(19) United States
(12) Patent Application Publication
(10) Pub. No.: US 2003/0131745 A1
(43) Pub. Date: Jul. 17, 2003

(54) Roller for industrial uses or printing uses

(76) Inventors: Alexander Sauer, Berlin (DE); Mathias Zisenis, Berlin (DE)

Correspondence Address: CONNOLLY BOVE LODGE & HUTZ LLP, 1220 Market Street, P.O. Box 2207, Wilmington, DE, 19899, US

(21) Appl. No.: 10/047,167

(22) Filed: Jan. 15, 2002

(51) Int. Cl. B41F 13/10

(52) U.S. Cl. 101/375

(57) ABSTRACT

A roller for industrial uses or printing uses essentially consists of non-metallic materials. The roller particularly comprises a roller core or a roller base of nonmetallic material. Besides, also bearing seats and bearings are preferably made of non-metallic material. The roller is applied in usual industrial and graphic applications. The roller can be used in a one-way procedure and be supplied to a chemical, mechanical or thermal recycling process directly after use.

### FIELD OF THE INVENTION

The present invention relates to a roller for industrial or graphic applications, which is developed that way that it comprises as few as possible metallic elements or construction units, such that it can be supplied to a recycling process after use directly.

### BACKGROUND

For industrial uses and printing uses a multiplicity of roller types is well-known. In industrial applications these find for example use for the transport of goods, webs or media (e.g. transport rollers, idler rollers, draw rollers or metering rollers), for the mechanical treatment of surfaces or substances (e.g. peeling rollers or squeeze rollers) or for the application of solid or liquid media on a surface (e.g. embossing rollers, laminating rollers, coating rollers or glue application rollers). In graphic applications rollers find for example use in printing machines or varnishing machines. Depending upon their respective function therein they are called for example varnishing roller, pan roller, fountain roller, ductor roller, transfer roller, distributor roller, oscillating roller, form roller or impression roller.

All these rollers is together that they besides a roller cover on basis of elastomeric or elastic plastics still comprise substantial components on basis of metallic materials, e.g. roller cores, roller bases and bearing seats. These are formed in such a way that the rollers durably withstand the respective mechanical and dynamic stresses which they are exposed to in their use. After use these rollers are usually supplied to a reconditioning process in which the roller core or roller base is released from the roller cover and re-covered with a new roller covering. Thus an enormous expenditure is connected on the part of the enterprise which uses the roller, in particular with the return of the occasionally quite heavy rollers, and on the part of the roller manufacturer with the transport and the handling of the rollers in connection with the re-covering. Particularly if the enterprise is far distant from the roller manufacturer, for example in another country or continent, the transport of the rollers becomes expensive and time-consuming. In order that the enterprise can nevertheless ensure its short response time to failures in the production or changed production runs, demanded in the daily business, it is demanded to keep, besides those rollers in use or sent to renewal, an extensive spare parts depot (i.e. to keep further rollers on stock).

### THE INVENTION

On this background the task existed to provide rollers for industrial and graphic applications whose use and handling are clearly improved. This task is solved by the fact that rollers are made available which essentially consist of non-metallic materials.

The invention therefore relates to a roller for industrial uses or printing uses which essentially consists of non-metallic materials. Opposite to commercial rollers, these rollers particularly comprise roller cores or roller bases from non-metallic materials.

The roller according to the invention can be equipped with bearings if necessary. Besides, depending upon its application, it may comprise functional elements which for instance serve for keeping at a moderate temperature or for the movement (e.g. oscillating, vibrating, swinging) of the roller. The bearings and the functional elements can optionally consist of metallic or non-metallic materials. Preferably they contain essentially non-metallic materials.

In principle, the roller according to the invention can be provided with a new roller covering after wear as well. Favorably, however, it is used in a one-way procedure, i.e. it is supplied to a disposal process or a recycling process after use directly. For ecological reasons a chemical, mechanical or thermal recycling process is recommended, in which for example inorganic and organic components of the roller material are separated, the roller material is decomposed into low-molecular chemical components or into reusable particles, e.g. chips, granulates or grinding stock, or wherein the thermal energy of the roller material is used. On the one hand transport costs are minimized by the one-way procedure, on the other hand less rollers are to be procured on the part of the enterprise, since besides the rollers in use and the spare parts depot no further rollers are needed. The rollers can be kept on stock also by the roller manufacturer and supplied on call, so that the storekeeping and the response time for the enterprise are evidently reduced.

### DESCRIPTION OF THE FIGURES

The FIGS. 1 to 3 schematically show possible embodiments of the roller according to the invention. Accordingly, a roller with a roller core 1 and a roller cover 2 is illustrated in FIG. 1. To use the roller it is provided with bearings 3 and inserted into appropriate supports. The bearings 3 can optionally be installed later or be an integrated component of the roller according to the invention. The roller core 1 can be implemented inside filled out (e.g. rod-shaped) or inside hollow (e.g. tubular). It can be manufactured in one piece from a non-metallic material, but it can also be developed from several parts or layers, for example shell-like, wound, as hollow covering or as a jacket filled out with a material. Besides, tubular roller cores may comprise supporting elements such as back-up rings or supporting disks or reinforcing structures such as bracings, lattices or networks.

FIG. 2 shows a roller with a roller cover 2, a roller base 4 as well as bearing seats 5, which optionally comprise bearings 3. The roller base 4 can be implemented inside filled out (e.g. rod-shaped) or inside hollow (e.g. tubular). It can be manufactured in one piece from a non-metallic material, but it can also be developed from several parts or layers, for example shell-like, wound, as hollow covering or as a jacket filled out with a material. Besides, tubular roller cores may comprise supporting elements such as back-up rings or supporting disks or reinforcing structures such as bracings, lattice or networks. The bearing seats 5 can consist of the same material as the roller base 4 or of another material. Roller base 4 and bearing seats 5 may consist of one or more pieces. If the bearing seats 5 are separate construction units, then favorably centered recesses are provided for the admission of the bearing seats 5 at the faces of the roller base 4. Depending upon the used materials, however, the bearing seats 5 can be connected with the roller base also by other techniques, for example by welding methods or sticking procedures.

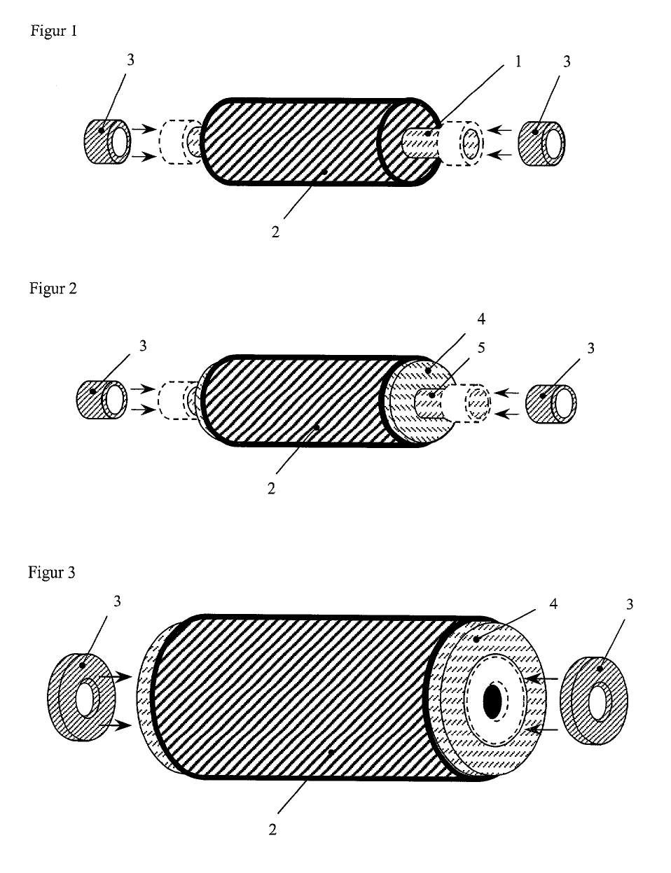

In FIG. 3 a roller is shown wherein the faces of the roller base 4 are provided with centered recesses or with arrangements for the direct admission of bearings 3. Favorably, for this purpose the faces are formed disk-shaped.

### DETAILED DESCRIPTION OF THE INVENTION

Roller cores 1 and roller bases 4 of the roller according to the invention essentially consist of non-metallic materials on basis of non-reinforced or reinforced plastics (polymer composite materials), ceramic(s) or polymer-bound mineral castings. Bearings 3, which both can be implemented as roller bearings or sliding bearings, and bearing seats 5 optionally consist of commonly known metallic materials and/or of non-metallic materials on basis of reinforced or non-reinforced plastics, ceramic(s) or polymer-bound mineral castings. Preferably, the bearings 3 and bearing seats 5 essentially consist of non-metallic materials. The roller cover 2 may consist completely of an elastomeric or elastic plastic or, having a multi-layer structure, comprises at least one layer from an elastomeric or elastic plastic material. Preferably this is the outside layer forming the surface-layer of the roller cover. Further layers of the roller cover 2 may also comprise essentially nonmetallic materials on basis of impregnated textiles, reinforced or non-reinforced plastics, ceramic(s) or polymer-bound mineral castings.

To the reinforced or non-reinforced plastics among others thermoplastic and thermosetting plastics, which comprise usual fillers and additives and optionally fibrous, spherical, powdery or particle-like reinforcing materials from inorganic or organic materials, as well as so-called High Tech polymers or engineering plastics, which partially can be processed by procedures untypical for plastics, e.g. by compression molding or sintering, belong. In fiber-reinforced plastics continuous fibers as well as short fibers with an average fiber length of from approx. 10 to 300 μm and/or long fibers with an average fiber length of more than 300 μm up to 50 mm, preferably of from 0.4 mm to 10 mm, can be present. Continuous fibers and long fibers preferably are incorporated into the respective plastic by a pultrusion process. Examples for fiber materials are carbon fibers (CRP), synthetic fibers (SRP), glass fibers (GRP) as well as mineral, ceramic or metallic fibers. Non-fibrous reinforcing materials may consist of the same materials as the fibrous reinforcements and have similar average sizes. The portion of reinforcing materials in the plastic is usually of approx. 30 to 70% by weight, preferably of more than 50% by weight. Reinforcing materials can be distributed in the plastic homogeneously, particularly fibrous reinforcing materials can also be present in the form of two- or three-dimensional textile structures, e.g. as fabrics, networks or fleeces.

To the ceramic materials for example mineral ceramics, glass ceramics, ceramels, organic ceramics or polymer ceramics (sinterable plastics on basis of silicon, e.g. silicon nitride) belong. Of these materials for instance shaped parts (e.g. bearing seats or bearings), thin layers or fibers can be made.

Polymer-bound mineral casting is also known under the designations concrete polymer composite and reaction resin concrete. It essentially comprises bonding agents on basis of a synthetic resin (e.g. epoxy resin or polyester resin) as well as usually inorganic, silicate filler (e.g. quartz, granite, basalt). The portion of the synthetic resin usually is of 5 to 15% by weight. These materials are well-known in mechanical engineering where they are used for example as construction material for machine supports or for filling out interiors or gaps. Regarding the rollers according to the invention, these materials can be used for instance for the production of molded roller cores, tubular layers in roller bases or of bearing seats.

As elastomeric or elastic plastic material for the roller cover 2

a) vulcanized rubbers like synthetic rubber, e.g. acrylonitrile butadiene rubber (NBR, HNBR, XNBR), ethylene rubber (CM, CSM), ethylene propylene rubber (EPM, EPDM), styrene butadiene rubber (SBR, XSBR), butyl rubber (IIR), polyisoprene rubber (IR), ester and ether polyurethane rubber (AU, EU), polyacrylic rubber (ACM), ethylene acrylic rubber (EAM), epichlorohydrine rubber (CO, ECO, ETER), polynorbornene rubber (PNR), silicone rubber (MQ, MFQ, MVQ, MPQ, MPVQ), fluorocarbon rubber (FKM), chloroprene rubber (CR) or natural rubber (NR),

b) elastic thermoplastics, e.g. polyvinyl chloride (PVC) or elasticized polyolefin (e.g. PP-EPDM),

c) thermoplastic elastomer (TPE), e.g., styrene block copolymer (e.g. SBS, SEBS, SIS), co-polyester elastomer or thermoplastic polyurethane (TPU),

d) castable or foamable plastic materials or mixtures of the components mentioned can be used as basis.

The elastomeric or elastic plastic material is to be selected and modified according to the targeted application and the function of the respective roller. Additionally, it may comprise usual additives, in particular coloring agents, fillers, reinforcing materials, softeners and/or fibrous material as well as further functional additives, for example substances for adjusting the hydrophilic or hydrophobic properties of the roller surface. These can be admixed to the plastic material of the covering or—in the case of the functional additives—bond to the plastic material by chemical reaction or polymerization.

At the production of the rollers, the rubber is usually cross-linked by vulcanization and thereby receives the desired durability, while elastic thermoplastics, thermoplastic elastomers and castable and/or foamable plastics attain their durability by cooling from the melt. Optionally, the roller cover can be applied directly onto the roller core or roller base during its production or is manufactured separately and mounted to the roller core or roller base afterwards. If a covering of elastomeric or elastic plastic forms the outside layer of the roller cover, then this layer usually becomes grinded on its surface in order to obtain a certain surface roughness or a certain, for example cylindrical, conical or spherical, shape of the roller cover. If required, the covering of the roller cover may also have cuts, shapings, textures or aggravations. For instance, the surface of the roller cover can be divided into two, three or more ranges by cuts, or be provided with radial or axial engravings.

Roller cores and roller bases of the roller according to the invention are essentially cylindrical in many applications. For certain applications, however, they can also have other forms. For instance they can be spherically, or conically to one or both sides. For optical, chemical or mechanical modification, particularly roller cores, roller bases, bearings and bearing seats can be subjected to methods of surface treatment such as plasma treatment, powder coating, metallization, galvanizing etc.

The roller according to the invention can be applied in the applications usual for rollers and replace there similar rollers with metallic roller cores or roller bases easily. The respective material selection and construction of the roller core, the roller base as well as of the bearings and bearing seats particularly depend on the expected dynamic and static load of the roller. The material selection and the execution of the roller covers particularly depend on the intended function of the roller and on the media getting into contact with the roller cover at use. If the respective requirements are fulfilled, also recycling materials can be used as materials with no trouble.

The rollers according to the invention are suitable for industrial applications, for example in industries processing wood, cardboards, paper, plastics, packaging, food, textiles, steel or other metals, in industries related to electrical engineering or photography, or in conveying or transportation systems, as well as for graphic applications such as letter press printing, offset printing, rotogravure printing, flexographic printing or special printing processes. They are for instance used as pan roller, fountain roller, ductor roller, transfer roller, distributor roller, form roller or impression roller in ink units, dampening units or varnishing units of rotary web-fed printing presses and sheet-fed printing presses, for the transport of goods, webs and liquid media, for example as transport roller, driving roller, draw roller, web lead roller, idler roller, stretching roller, dip roller, flow roller, laminating roller or glue roller, as well as for the mechanical treatment of surfaces or non-liquid media, for example as pressure roller, peeling roller, slitting roller, squeezing roller, nip roller or embossing roller.

What is claimed is:

1. A roller for industrial or printing uses, wherein the roller essentially consists of non-metallic materials.

2. The roller according to claim 1, wherein the roller comprises a roller core, or a roller base with bearing seats or recesses for the admission of bearings, and a roller cover.

3. The roller according to claim 2, wherein said roller core or said roller base essentially consists of non-metallic materials.

4. The roller according to one of the claims 1 to 3, wherein the roller comprises bearings which optionally essentially consist of metallic or nonmetallic material.

5. The roller according to one of the claims 1 to 4, wherein the roller comprises functional elements which optionally essentially consist of metallic or non-metallic material.

6. The roller according to one of the claims 1 to 5, wherein said non-metallic material essentially comprises
non-reinforced plastic,
polymer composite material, in particular fiber-reinforced composite on basis of CRP, GRP or SRP, where the fibers optionally are present as short fibers, long fibers and/or continuous fibers and long fibers and/or continuous fibers are preferably processed by pultrusion,
ceramic material, in particular glass-ceramic, metal-ceramic or polymer-ceramic material which optionally comprises reinforcing materials
or polymer-bound mineral cast or a composite material thereof.

7. The roller according to one of the claims 2 to 6, wherein said roller cover comprises one or more layers, of which at least one, preferably the outside layer, comprises elastomeric or elastic plastic material, in particular an elastomer or an elastic plastic on basis of
vulcanized rubber, in particular acrylonitrile butadiene rubber (NBR, HNBR, XNBR), ethylene rubber (CM, CSM), ethylene propylene rubber (EPM, EPDM), styrene butadiene rubber (SBR, XSBR), polyisoprene rubber (IR), butyl rubber (IIR), ester and ether polyurethane rubber (AU, EU), polyacrylic rubber (ACM), ethylene acrylic rubber (EAM), epichlorohydrine rubber (CO, ECO, ETER), polynorbornene rubber (PNR), silicone rubber (MQ, MFQ, MPQ, MVQ, MPVQ), fluorocarbon rubber (FKM, FFKM), chloroprene rubber (CR) or natural rubber (NR),
elastic thermoplastic material, in particular polyvinyl chloride (PVC) or elasticized polyolefin,
thermoplastic elastomer (TPE), in particular styrene block copolymer (SBS, SEBS, SIS), co-polyester elastomer or thermoplastic polyurethane (TPU),
cast or foamed plastic material, in particular on basis of polyurethane, or mixtures thereof.

8. A process of use of a roller in accordance with one of the claims 1 to 7
in printing machines or varnishing machines, in particular in rotation offset printing machines or sheet-fed offset print machines,
for transmitting liquid media, in particular as ink roller, dampening roller, varnishing roller, glue roller, dip roller or flow roller or
as transport roller, drive roller, draw roller, web lead roller, stretch roller, laminating roller, pressure roller, peeling roller, slitting roller, squeezing roller, nip roller or embossing roller.

9. A process for the recycling of a roller in accordance with one of the claims 1 to 8, wherein essentially a complete roller is supplied to a recycling procedure, in particular a chemical, mechanical or thermal recycling procedure, after use.

10. A process for the manufacturing of a roller for industrial or graphic applications, wherein essentially non-metallic materials are used for the production of the roller.
